(19) United States
(12) Patent Application Publication
(10) Pub. No.: US 2009/0320579 A1
(43) Pub. Date: Dec. 31, 2009

(54) Method and device for measuring an effective normal force on a disk brake

(75) Inventors: Johannes Ante, Regensburg (DE); Stephan Heinrich, Pfeffenhausen (DE); Andreas Ott, Steinsberg (DE); Willibald Reitmeier, Hohenschambach (DE)

Correspondence Address: COHEN, PONTANI, LIEBERMAN & PAVANE LLP, 551 FIFTH AVENUE, SUITE 1210, NEW YORK, NY, 10176, US

(73) Assignee: CONTINENTAL AUTOMOTIVE GMBH, München (DE)

(21) Appl. No.: 12/308,972

(22) PCT Filed: May 31, 2007
(86) PCT No.: PCT/EP2007/055351

§ 371 Date: Feb. 20, 2009

(30) Foreign Application Priority Data
Jun. 29, 2006 (DE) 10 2006 029 978.7

(51) Int. Cl. G01L 5/28

(52) U.S. Cl. 73/121

(57) ABSTRACT

A method and a device for measuring a normal force affecting a disk brake that is used particularly in motor vehicles. In order to further develop a device for measuring an effective normal force so as to significantly decrease the additional mounting space required in the area of a disk brake and reduce sensitivity to thermal influences, a shearing movement of a part of the disk brake relative to a reference is detected by a sensor such that a test signal-processing logic circuit can draw conclusions about an actually effective normal force based on a sensor test signal.

The present invention relates to a method and to a device for measuring an acting normal force on a disk brake such as is used, in particular, in motor vehicles.

A disk brake of a known design has a disk brake which runs along on the hub of a wheel to be braked and against which friction linings in the form of brake shoes or brake linings are pressed from both sides. These friction linings are attached in what is referred to as a brake caliper. The brake caliper engages around the disk brake. The brake is generally activated hydraulically using at least one brake piston as an actuator. In motor vehicles, the partial disk brakes, that is to say disk brakes which use only part of the surface of the disk as a friction face, are generally used.

In addition, in automobiles, what are referred to as floating caliper brakes are preferably used. Floating caliper brakes have, in contrast to fixed caliper brakes, the actuators on just one side of the disk. The design of the floating caliper brake permits the braking force to be built up on both sides of the brake caliper basically by means of just one actuator. The brake caliper which has longitudinally displaceable mounting or floating mounting transmits the pressure applied by just one actuator to the other side of the brake disk by mechanical means. As a result of this design, floating caliper brakes require only comparatively small installation space, with the result that a floating caliper brake can be positioned better compared to fixed caliper brakes when the installation height is small. In addition, floating caliper brakes have a high level of efficiency and are comparatively simple in terms of design and maintenance. For example, in particular friction linings or brake linings can be replaced in a short time.

In an even simpler design with smaller dimensions, the floating caliper disk brake is used as what is referred to as a hinged caliper brake in motor cycles.

In known disk brakes, hydraulically activated pistons are used as the actuator, which pistons can be displaced by means of hydraulic pressure in corresponding activation devices. In the case of an electromechanically activated disk brake, an electromechanical actuator is used instead of a hydraulic cylinder. In this context, a self-energizing device, by means of which an activation force which is generated by the electromechanical actuator is automatically boosted during a braking process and without further extraneous energy being supplied, can also be arranged between at least one electromechanical actuator and at least one friction lining.

In principle, in the case of a disk brake with an electromechanical actuator there is no feedback of an acting braking force on a brake pedal, as occurs in conventional brakes via the hydraulic circuit. In addition, a further significant disadvantage of floating caliper brakes is a greater degree of torsion. Such elastic deformations result in a pressure point which is less precise compared to that of fixed caliper brakes. In a disk brake with an electromechanical actuator, it is therefore generally necessary, in particular because of the two points mentioned above, to sense continuously and as precisely as possible a currently acting braking force during operation independently of the exact structural embodiment of said disk brake. Only on this basis can the disk brake be controlled reliably and with a necessary degree of precision in order to comply with a braking request which is predefined by a user and also to be able to give feedback to this user. In this context, the term “currently acting braking force” is understood below to mean a force which is acting between the friction linings and the brake disk in a normal direction with respect to the surface of the brake disk and which is brought about at the brake disk with friction linings pressed against it for the purpose of braking.

Various approaches for determining a current braking force are known from the prior art. These approaches usually build on deformation of a sensor element which is introduced into the force flux of a brake. As a result, such sensor elements are generally located in a region of a brake which is loaded to a very high degree by dirt and high temperatures, with the result that these sensors are either specially protected owing to the adverse conditions of use and/or are comparatively expensive owing to the stringent requirements made of them in terms of service life and reliability even under tough conditions of use.

In a patent application by the applicant which was not published before the priority date of the present document, a partially slotted brake caliper is used to measure a current normal force on a disk brake. Elastic widening of the brake caliper is used as a measurement variable for measuring a current braking force, wherein a component with a first end which is attached to the brake caliper and a second, free end is used for the measurement process. Between the brake caliper and this component, there is, in the direction of a longitudinal extent of the component, a gap whose respective current gap width is measured as a measure of a currently acting braking force and is subsequently evaluated. In this context, spreading the brake caliper relative to the component or reference box bar of the brake caliper to which force is not applied is therefore measured. For this purpose, for example, an electromechanical or electro-optical travel measuring means is used at the slot. An amount of force-proportional travel at the slot is approximately 0.5 mm in one embodiment. In order to convert a respectively measured amount of travel into a currently acting force, it is assumed that the brake caliper deforms in a linearly elastic fashion with a good degree of approximation in a measuring range of interest. A change in the slot width is measured by means of travel measuring pickups, for which probes or distance sensors based on inductive or capacitive measuring methods, such as for example what are referred to as linear variable displacement transducers or LVDTs or Hall cells, can be used.

For thermally induced zero point drift and/or non-linearities of an output signal, compensation measures are provided, and measured value tables which are produced by reference sensors are provided for calibrating the measuring device.

The object of the present invention is to develop a device for measuring an acting normal force with a significant reduction in the installation space which is additionally required in the region of a disk brake, and with a reduction in sensitivity to thermal influences.

This object is achieved by means of the features of the independent claims. Advantageous developments are the subject matter of the respective subclaims.

According to the invention, a shearing movement of part of the disk brake relative to a reference is detected or sensed by a sensor in order to draw conclusions about a currently acting normal force on the basis of a sensor measuring signal in a measuring signal processing logic. Owing to bending or twisting in reaction to application of a force, a disk brake often experiences an approaching movement or distancing movement as well as a shearing or “moving past” movement. The present invention makes use of this fact in order to use, instead of a distance or a displacement travel, strain sensors or travel sensors to evaluate a shearing movement of part of the disk brake as a component of an overall reaction, possible owing to the influence of a force, with respect to a reference located outside the force flux. Accordingly, by virtue of this new approach it is then also possible to select other positions for a corresponding sensor in the region of a disk brake. These positions can be defined here by smaller installation space restrictions and also by lower operating temperatures, as is also represented with reference to the drawing with diagrams relating to exemplary embodiments of the invention.

The use of inductive eddy current sensors is particularly advantageous. Such sensors use a magnetic coil to generate a magnetic alternating field which is damped, due to eddy currents, by an opposing body or target which is placed in the magnetic field. The closer a target, the greater the degree of damping. The degree of damping in a particular instance is measured in a device and converted into a currently acting force, for example with respect to a distance of the sensor in relation to the target. However, these eddy current sensors which operate in a contactless fashion can also measure displacement with respect to an electrically conductive measured object in a wear-free fashion. The measured object may basically have both ferromagnetic and non-ferromagnetic properties. A material which is particularly suitable for eddy current measurements and which supplies very clear output signals is preferably used as the target here. This measuring principle is very well suited for application in the raw environment of a disk brake owing to the low level of sensitivity to, for example, oil, dirt, moisture, dust and interference fields. Such sensors with a high degree of precision and resolution in their measuring are available on the market in compact designs with a very good price/performance ratio. A sensor electronic system which is generally already available in miniaturized form can be arranged here either directly at the measurement location or in a central signal processing component.

According to the invention, the magnetic coil of at least one eddy current sensor and a target therefore carry out a shearing movement with respect to one another. If a shearing movement is measured instead of proximity it is possible to switch to a different installation space in the region of the disk brake. As a result, new degrees of freedom of design and expansion of the system are acquired even for a given design of a disk brake or of a sensor unit. In particular, it is therefore possible, in designs in which there is no longer any space available for a proximity sensor, nevertheless to measure a shearing movement at another location of a disk brake where sufficient installation space is still available.

In one preferred embodiment of the invention, the target has a step. In a particularly advantageous embodiment of the invention, this step of the target is embodied with a specific geometry, with the result that the sensor is given a desired, and in particular linear, characteristic curve. This measure allows subsequent electronic linearization of a characteristic curve to be made significantly easier or even to be eliminated entirely.

The eddy current sensor is advantageously inserted into a brake in such a way that a region of the brake caliper itself serves as a target for the measurement of a shearing movement. The brake caliper material is usually gray cast iron or aluminum or aluminum alloys. However, basically, materials which are also suitable particularly for eddy current measurements can be used as the material for a target.

Further features and advantages of the invention are specified below accompanied by descriptions of exemplary embodiments and with reference to the figures in the drawing. In said drawing:

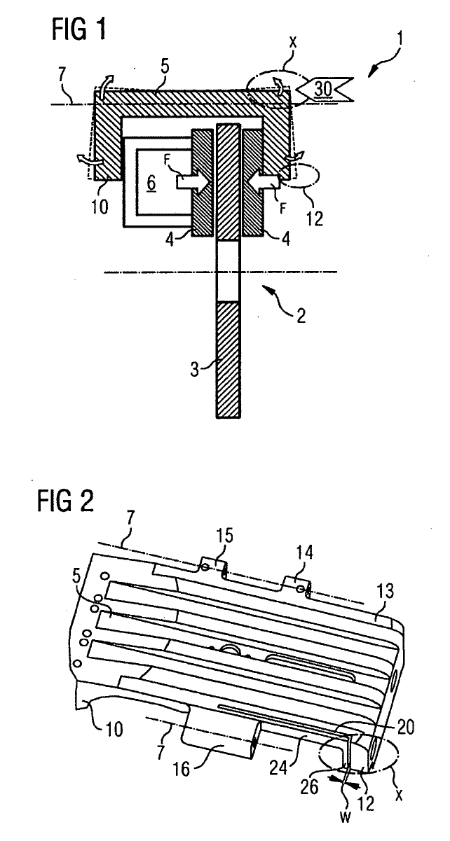

FIG. 1 is a schematic sectional diagram of a basic design of a floating caliper disk brake with indication of the deformations occurring in the region of a brake caliper under the influence of a braking force;

FIG. 2 shows a brake caliper of a disk brake in a spatial illustration from above, viewed in the direction of a brake disk, with indication of an essentially L-shaped, arm-like component for measuring the braking force or evaluating the widening of a gap;

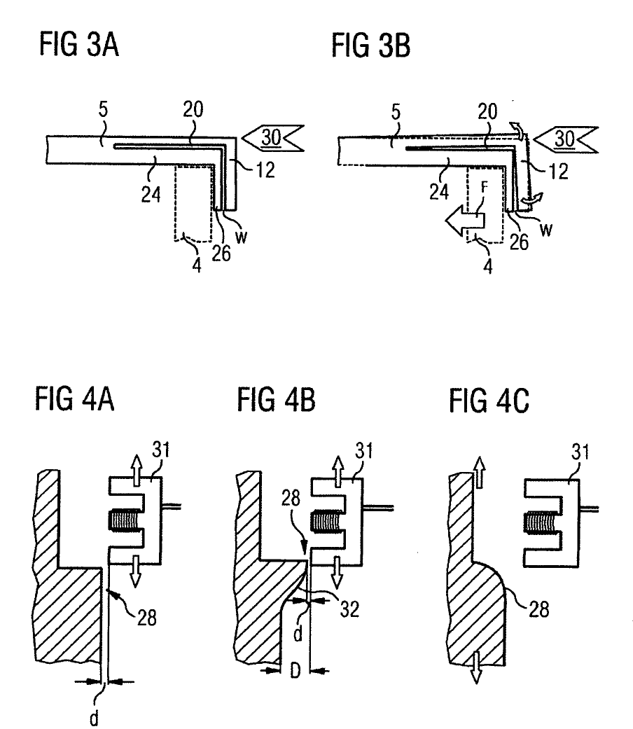

FIGS. 3a and 3b show details from the drawings in FIGS. 1 and 2 in order to illustrate an unloaded state and a state in which braking force is applied, with the different measuring principles being indicated;

FIGS. 4a to 4c show schematic sectional illustrations of an electromagnetic sensor head in conjunction with various designs of an opposing body, which each have different shaped steps for generating different characteristic curves of the eddy current sensor, and

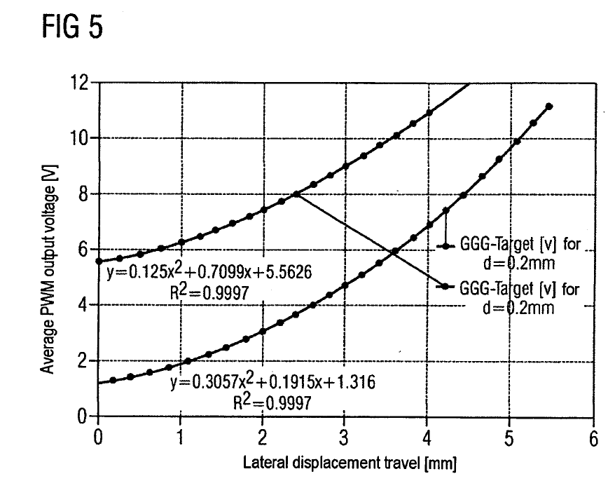

FIG. 5 shows a diagram illustrating measured sensor output voltages as a function of a respective displacement travel with parameterization by means of a distance between the sensor head and target.

In the text which follows, the same reference numerals and designations are used on a standard basis for identical parts, functions or assemblies and method steps via the various figures and exemplary embodiments.

FIG. 1 is a schematic illustration of a basic design of a floating caliper disk brake 1 for a motor vehicle in section.

The disk brake 1 has a brake disk 3 which runs along on a hub 2 of a wheel (not illustrated in more detail) and against which friction linings 4 in the form of brake linings are pressed from both sides within the scope of a braking process. These friction linings 4 are attached in a brake caliper 5 which extends around the brake disk 3. The illustrated disk brake 1 has, as a floating caliper brake, just one actuator unit 6 which is arranged on one side of the brake disk 3.

In order to transmit the braking force to both sides of the brake disk 3 in a substantially uniform fashion, the brake caliper 5 is mounted so as to be longitudinally displaceable on an axle 7, with the result that said brake caliper 5 applies a contact pressure force F applied by the actuator unit 6, to both sides of the brake disk 3 in a uniform fashion.

In the present example, an electromechanically acting actuator unit 6 is to be used in the disk brake 1. Compared to known hydraulic disk brakes, in an electromechanically activated disk brake, there is no feedback concerning a braking force implemented at the disk brake 1 to a driver. In addition, floating caliper disk brakes have the disadvantage of relatively large elastic deformation or twisting, with the result that a pressure point which can be defined only imprecisely is produced. These two properties mentioned above make it necessary for a braking force which is currently acting on the brake disk 3 during operation to be determined continuously and as precisely as possible.

Building on a solution, not published before the priority date of the present document, for determining a currently acting normal force, advantageous refinements with various exemplary embodiments will now be discussed with recourse to the disclosure of a patent application which was not published before the priority date of the present document. In this respect, FIG. 2 shows a three-dimensional illustration of the brake caliper 5 with an overall U shape which engages over a brake disk 3 (not illustrated here in more detail) and arms 10, 12 which extend at a right angle in the same direction and have the purpose of holding the brake linings 4 (likewise not illustrated in FIG. 2). The arms 10, 12 are therefore connected integrally to the brake caliper 5 with corresponding mechanical reinforcement through ribs 13. A floating bearing of the entire disk brake 1 by means of the brake caliper 5 is brought about at two axles 7 by means of guides 14, 15, 16, which are also connected integrally to the brake caliper 5.

In addition, a device for measuring a current braking force is provided at the brake caliper 5 which measures elastic widening of the brake caliper 5 in reaction to an acting braking force F by increasing a width w of a gap 20. This gap 20 is located between an essentially L-shaped component 24 which is connected in an arm-like fashion at one end to the brake caliper 5 and whose free, second end 26 serves to measure the gap width w.

The details X of FIGS. 1 and 2 are represented once more in schematic form in a detail in order to clarify the teaching of a patent application which was not published before the priority date of this document, and in order to clarify the new measuring approach in FIGS. 3a, 3b. Accordingly, a width w of the gap or its widening, brought about under the influence of the braking force F at the transition from FIG. 3 to FIG. 3b is measured in the region of the free end 26 of the component 24 in a region which is at the level of the brake linings 4. This measurement is carried out as travel measurement or distance measurement.

In contrast to this, according to a new approach, shearing an edge 28 owing to the effect F of a force is evaluated by an eddy current sensor 30. Since the edge 28 is present over the entire depth of the brake caliper 5 and is loaded in the same way under the effect of a force by the force F in the course of the braking process, the position of the eddy current sensor 30 along this edge 28 which is selected by way of example can be freely selected within wide ranges in accordance with a respectively available installation space.

The sequence of FIGS. 4a to 4c shows exemplary embodiments of different types of shaping in the region of the edge 28. For example, FIG. 4a shows a simple edge 28 which runs in the form of a step and which brings about a sudden change in a large distance between the magnetic head 31 and an electrically conductive edge material to a minimum distance d when a magnetic head 31 of the sensor 30 moves.

FIG. 4b shows the step edge of FIG. 4a with a following, curve-like rear section. As a result of this undercut 32 of the edge 28, after the sudden reduction in a large distance between the magnetic head 31 and target in the region 28 from the distance d to a subsequently further enlarged distance D, a correspondingly significant change in the output signal of the sensor 30 is brought about.

FIG. 4c shows a continuous and monotonous curve profile of the edge 28 by means of which a curve profile of the output signal of the sensor 30 can be influenced viewed over a distance. In particular, by means of the measures, presented above, for the shaping in the region of the edge 28, a large degree of linearization of the output signal profile can be achieved over a displacement travel. In this context, it is, of course insignificant whether the sensor element 30 is displaced relative to the target or the edge 28, as is the case in the FIGS. 4a, 4b, or whether the target or the edge 28 is displaced relative to a fixed sensor element 30, as is the case in FIG. 4c.

FIG. 5 shows two measurements of a shearing movement by means of an eddy current sensor on a target which is embodied in a step shape and is composed of cast iron, over a comparatively large lateral displacement travel up to 5 mm in length. Both measuring curves can be approximated as parabola or second degree functions in the manner illustrated. They differ clearly from one another here owing to the very different minimum distances from the target. For example, given a distance d=0.2 mm, the significantly higher output signal voltages are reached, while even a distance of the target from the sensor of d=2.0 mm supplies an output signal which can be evaluated without disruption and can be distinguished clearly over the entire measuring range.

1-9. (canceled)

10. A method for measuring an acting normal force on a floating caliper disk brake comprising:
detecting a shearing movement of a part of the floating caliper disk brake using a sensor; and
analyzing an output of the sensor to determine characteristics of a currently acting normal force of the floating caliper disk brake.

11. The method according to claim 10, wherein the sensor is configured to detect eddy currents, and a part of the brake caliper of the floating caliper disk brake is a target of the sensor, the method further comprising:
moving the sensor and the target past one another in the course of the shearing movement.

12. The method according to claim 11, wherein the target is at least one of an edge and a step.

13. The method according to claim 12, wherein the at least one of the edge and the step is configured such that the sensor output signal is a linear characteristic curve.

14. A device for measuring an acting normal force on a caliper disk brake, comprising:
a sensor arranged relative to a target and configured to detect a shearing movement between the sensor and the target caused by a braking force currently acting on the caliper disk brake, wherein the target is a part of the caliper disk brake; and
a processing logic coupled to the sensor configured to determine the braking force currently acting on the caliper disk brake.

15. The device according to claim 14, further comprising a brake caliper configured to apply the braking force, wherein the target of the sensor is part of a brake caliper.

16. The device according to claim 15, wherein the target is at least one of an edge and a step.

17. The device according to claim 16, wherein the at least one of the edge and the step is configured relative to the sensor so that the sensor exhibits a linear force-movement characteristic curve.

18. The device according to claim 15, wherein the sensor is an eddy current sensor.

19. The device according to claim 15, wherein the caliper disk brake is a floating caliper disk brake.

20. The device according to claim 15, wherein the brake caliper comprises a pair of essentially L-shaped components connected at one end having a slot therebetween, wherein the braking force causes a width of the slot to vary.

21. The device according to claim 20, wherein the target is configured at a free end of one of the L-shaped components.

22. The device according to claim 21, wherein the target is electrically conductive.

23. The device according to claim 22, wherein the target is one of a step and a curve.

24. The device according to claim 23, wherein the distance between the target and the sensor varies between about 0.2 mm and 2 mm.
